(19) United States
(12) Patent Application Publication
(10) Pub. No.: US 2022/0067573 A1
(43) Pub. Date: Mar. 3, 2022

(54) IN-PRODUCTION MODEL OPTIMIZATION

(71) Applicant: ACCENTURE GLOBAL SOLUTIONS LIMITED, Dublin (IE)

(72) Inventors: Emmanuel MUNGUIA TAPIA, San Jose, CA (US); Anwitha Paruchuri, San Jose, CA (US); Abhishek Mukherji, Fremont, CA (US); Anshuma Chandak, San Jose, CA (US)

(73) Assignee: ACCENTURE GLOBAL SOLUTIONS LIMITED, Dublin (IE)

(21) Appl. No.: 17/007,955

(22) Filed: Aug. 31, 2020

(51) Int. Cl. G06N 20/00; G06F 11/30; G06F 11/34

(52) U.S. Cl. CPC G06N 20/00; G06F 11/3495; G06F 11/302

(57) ABSTRACT

A model optimization system monitors a model deployed to an external system to determine the performance of the model and to replace the model with one of a plurality of models stored to a model repository if degradation of model performance is detected or if one of the models in the plurality of models is evaluated as having better performance than the model deploy the external system. A model evaluation trigger can be generated based on dates or data criteria. Various metrics are used in the model evaluation to calculate values of a model optimization function for each of the plurality of models. If a model that is better optimized than the deployed model is identified from the model evaluation, then the deployed model is replaced with the identified model and the external system continues to use the deployed model.

### BACKGROUND

One of the methodologies to create data models can include statistical data modeling which is a process of applying statistical analysis to a data set. A statistical model is a mathematical representation or a mathematical model of observed data. As artificial intelligence (Al) and machine learning (ML) gain prominence in different domains, statistical modeling is being increasingly used for various tasks such as making predictions, information extraction, binary or multi-class classification, etc. The generation of an ML model includes identifying an algorithm and providing the appropriate training data for the algorithm to learn from. The ML model refers to the model artifact that is created by the training data. The ML models can be trained via supervised training using labeled training data or via unsupervised training method.

### BRIEF DESCRIPTION OF DRAWINGS

Features of the present disclosure are illustrated by way of examples shown in the following figures. In the following figures, like numerals indicate like elements, in which:

FIG. 1 shows a block diagram of an ML model optimization system in accordance with the examples disclosed herein.

FIG. 2 shows a block diagram of an in-production metrics comparator in accordance with the examples disclosed herein.

FIG. 3 shows a block diagram of a model deployment evaluator in accordance with the examples disclosed herein.

FIG. 4 shows a block diagram of an adaptive deployment scheduler in accordance with the examples disclosed herein.

FIG. 5 shows a flowchart that details a method of optimizing an ML model deployed into production on an external system in accordance with examples disclosed herein.

FIG. 6 shows a flowchart that details a method of generating the model evaluation trigger in accordance with the examples disclosed herein.

FIG. 7 shows a flowchart that details a method of calculating a model optimization function in accordance with the examples disclosed herein.

FIG. 8 shows a graphical user interface (GUI) that enables configuring the adaptive deployment scheduler in accordance with the examples disclosed herein.

FIG. 9 shows a metrics configuration user interface (UI) generated in accordance with the examples disclosed herein.

FIG. 10 shows a model deployment UI provided by the model optimization system in accordance with the examples disclosed herein.

FIG. 11 illustrates a computer system that may be used to implement the model optimization system.

### DETAILED DESCRIPTION

For simplicity and illustrative purposes, the present disclosure is described by referring to examples thereof. In the following description, numerous specific details are set forth in order to provide a thorough understanding of the present disclosure. It will be readily apparent however that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

An ML model optimization system that monitors the performance of a model deployed to an external system and replaces the deployed model with another model selected from a plurality of models when there is a deterioration in the performance of the deployed model is disclosed. In an example, the external system can be a production system that is in use for one or more automated tasks as opposed to a testing system that is merely used to determine the performance level of different components. The model optimization system monitors the performance of the deployed model and performances of at least a top K models selected from the plurality of models by accessing different model metrics. The model metrics can include static ML metrics, in-production metrics, and category-wise metrics. The static metrics can include performance indicators of the plurality of models that are derived from training data used to train the plurality of models. The in-production metrics can be obtained based on human corrections provided to the model output that is produced when the external system is online and in-production mode. In an example, the top K models are selected or shortlisted based on the in-production metrics wherein K is a natural number and K=1, 2, 3, etc. The category-wise metrics include performance indicators of the models with respect to a specific category.

The model optimization system is configured to identify or detect different conditions for initiating a model evaluation procedure or for generating a model evaluation trigger. In an example, the different conditions can be based on date criteria and data criteria. The date criteria can include a predetermined time period in which the model evaluation trigger is to be periodically generated. The data criteria can further include a threshold-based criterion and a model-based criterion. The threshold-based criterion can include generating the model evaluation trigger upon determining that a particular percentage of the in-production corrections above a predetermined threshold were made to the output data of the ML model deployed to the external system. The model-based criterion includes generating the model-evaluation trigger upon determining that one of the top K models demonstrates a predetermined percentage of improvement in performance over the performance of the deployed model. In an example, the model optimization system can be configured for automatically learning the thresholds for deployment and the frequency of performing the evaluations and deployments. These time periods may be initially scheduled. However, the historical data for the different accuracy thresholds and evaluation/deployment frequency can be collected based on the timestamps and the threshold values at which newer models are deployed to the external system, along with the per category in-production accuracy for the duration of each deployed model. The historical data thus collected can be used to train one or more forecasting models with an optimization function or sequential learning models to automatically provide the model accuracy thresholds or time periods for generating the model evaluation triggers.

Initiating the model evaluation procedure or generating the model evaluation trigger can include providing an input to the model optimization system to begin calculating model optimization function values for at least the top K models. The model optimization function includes a weighted aggregate of different metrics. In an example, the weights associated with the different metrics can be initially provided by a user. However, with the usage of the model optimization system over time, the weights can be learnt and may be set automatically. Initially, the static metrics have the highest weight as the in-production metrics or the category-wise metrics are not available for the models. But as the model optimization system gathers performance data of the models, the in-production metrics and the category-wise metrics gain importance and hence are combined with increasing non-zero weights. The category-wise metrics are determined based on priorities assigned to a plurality of categories to be processed by the models. In an example, one of the plurality of categories may be assigned higher priority as compared to other categories and therefore the performance of the models with respect to the category with higher priority can carry greater weight. The category priorities in turn can be assigned based on forecasts generated for the categories from historical data. For example, if the data volume for a particular category is forecasted to increase as compared to other categories then that category can be assigned greater importance. The corresponding model optimization function values of the top K models are compared with that of the deployed model and a model with the highest model optimization function value is included within the external system for execution of the processing tasks. If one of the top K models has higher model optimization function value as compared to the deployed model, then the model with the higher value replaces the deployed model in the external system. However, if the deployed model has the highest value of the model optimization function then, it is continued to be used in the external system.

The model optimization system as disclosed herein provides for technical improvement in the field of model training and generation as it enables constant monitoring and improving models included in the production systems. Using only offline data for training the models may produce higher accuracy initially, e.g., 95 percent accurate output, however with usage in-production systems or while handline processing tasks online, the model accuracy can degenerate due to various reasons. For example, the model produces inaccurate output such as misclassifying input data, etc. One reason for the loss of the model accuracy is that typically the human-annotated training data may not be balanced for all categories. A model classifying all the categories from the beginning may be suboptimal. The model optimization system compensates for such disproportionate training data by assigning higher priorities to categories that are expected to have greater volumes.

Even if the training data initially used to train the model may be balanced, the data processed by the external system in the production mode may not necessarily be balanced. For example, in the case of classification models, there can be certain categories for which higher data volumes are expected. Furthermore, other issues such as new categories, vanishing categories, split, or merge categories can cause bootstrapping issues. This is because there can be insufficient training data for the new or modified categories as a result of which data to be classified into the new or modified categories can be misclassified into a deprecated/obsolete category. Prior probabilities of classes, p(y) may change over time. Class conditional probability distribution, p(X,y) may also change along with posterior probabilities p(y|X). The model optimization system in implementing a continuous monitoring framework enables actively monitoring, retraining, and redeploying the models and therefore enables the external system to handle concept drift.

Yet another consideration can include data safety and security. Users generally prefer the data to stay secure within the system that is processing the data. In such instances, the end-users do not prefer exporting the data to external systems and hence, off-line model training may not be possible. The model optimization system by integrating model training, monitoring, and re-deployment enables production systems to monitor their performances and address performance issues thereby improving data safety and security.

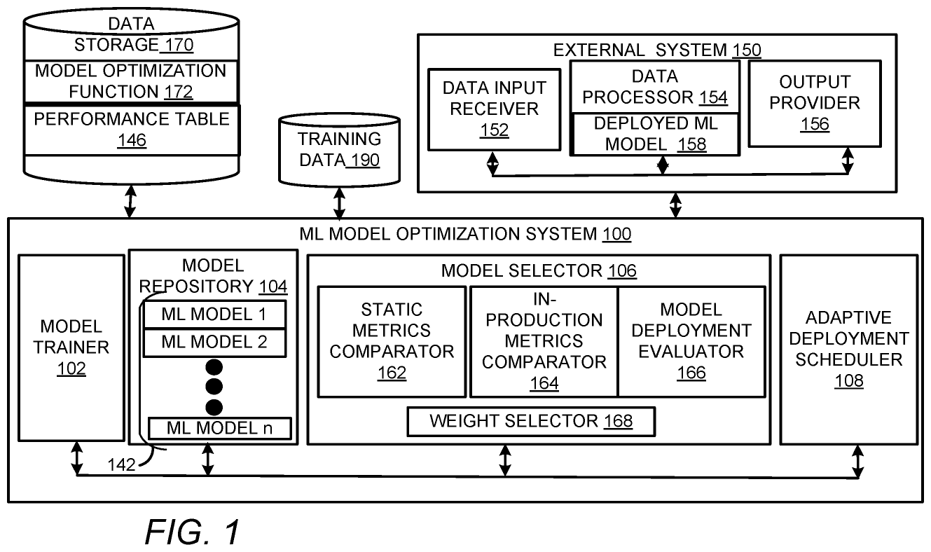

FIG. 1 shows a block diagram of an ML model optimization system 100 in accordance with the examples disclosed herein. The model optimization system 100 is configured to adaptively change an ML model 158 deployed to a production system e.g., the external system 150 based on performance evaluation of the deployed model 158. The external system 150 can include any data processing system that employs ML models such as the deployed ML model 158 for processing input data obtained, for example, by the data input receiver 152 and produce output via the output provider 156. By way of illustration and not limitation, the external system 150 can include a robotic process automation (RPA) system that receives user queries/messages, employs classifier models within the data processor 154 to classify the received user queries/messages and to automatically forward the classified messages to corresponding receivers based on a predetermined configuration of the output provider 156. Although only one deployed model is shown and depicted herein, it can be appreciated that similar evaluation processes can be applied parallel to multiple deployed models for evaluation and optimization purposes.

In an example, the external system 150 can be located at a physically remote location from the model optimization system 100 and coupled to the model optimization system 100 via networks such as the internet. An instance wherein the model optimization system 100 is provided as a cloud-based service is one such example. In an example wherein additional data security is desired, the model optimization system 100 may be an integral part of the external system 150 hosted on the same platform. Due to the various reasons outlined above, the deployed ML model 158 can lose accuracy and become inaccurate over time. The model optimization system 100 can be configured to determine various conditions under which the deployed ML model 158 is to be evaluated for performance and to replace the deployed ML model 158 with another ML model if needed so that the external system 150 continues to work accurately without a drop in efficiency. The model optimization system 100 can be communicatively coupled to a data storage 170 for saving and retrieving values necessary for the execution of the various processes.

The model optimization system 100 includes a model trainer 102, a model repository 104, the model selector 106, and an adaptive deployment scheduler 108. The model trainer 102 accesses the training data 190 and trains a plurality of models 142 e.g., ML model 1, ML model 2 . . . ML model n, included in the model repository 104 using the training data 190. By way of illustration and not limitation, the plurality of models 142 may include Bayesian models, linear regression models, logistic regression models, random forest models, etc. The model repository 104 can include different types of ML models such as but not limited to classification models, information retrieval (IR) models, image processing models, etc. The training of the plurality of models 142 can include supervised training or unsupervised training based on the type of training data 190. In an example, a subset of the plurality of model 142 can be shortlisted for replacing the deployed ML model 158 thereby saving processor resources and improving efficiency.

The model selector 106 selects one of the subset of the plurality of models 142 for replacing the deployed ML model 158. The model selector 106 includes static metrics comparator 162, an in-production metrics comparator 164, a model deployment evaluator 166, and a weight selector 168. The model selector 106 is configured to calculate a model optimization function 172. The model optimization function 172 can be obtained as a weighted combination of static ML metrics, in-production model performance metrics, and category-wise metrics. The weights for each of the components in the model optimization function 172 can be determined dynamically by the weight selector 168. For example, during the initial period of model selection, the weight selector 168 may assign a higher weight to the static ML metrics as opposed to in-production model performance metrics or category-wise metrics. This is because the performance of accuracy of the plurality of models 142 with the data handled by the external system 150 is yet to be determined. As one or more of the plurality of models 142 are used in the external system 150 the accuracies may be recorded by the weight selector 168 and the weights can be dynamically varied. In an example, the weight selector 168 can assign a higher weight to the category-wise metrics when it is expected that the external system 150 is to process data that predominantly pertains to a specific category.

The static metrics comparator 162 determines the accuracy of the plurality of models 142 upon completing the training by the model trainer 102 using the training data 190. A portion of the training data 190 can be designated as testing data by the static metrics comparator 162 so that the trained models can be tested for accuracy using the testing data. The in-production metrics comparator 164 determines the in-production performance accuracy of the plurality of models 142. In an example the input data received by the external system 150 can be provided to each of the plurality of models 142 by the in-production metrics comparator 164 and the top K models are determined based on the number of human corrections that are received for the output data e.g., predictions or results produced by each of the plurality of models 142 wherein K is a natural number and K=1, 2, 3, . . . Particularly, the output of each of the plurality of models 142 can be provided to human reviewers for validation. The higher the number of human corrections to the model output, the lower will be the accuracy of the ML model. Generally, the model optimization function 172 can include non-zero weights for the static performance metrics and in-production performance metrics. Whenever the external system 150 is expected to process the data associated with a specific category, the weight assigned to the category-wise metrics can be increased. The model deployment evaluator 166 calculates the value of the model optimization function 172 as a weighted combination of the components including the static metrics, the in-production performance metrics, and the category-wise metrics. In an example, the respective performance metrics of the top K models can be stored in the performance table 146. A model with the highest value for the model optimization function 172 is selected to replace the deployed ML model 158. In an example, the criteria for redeployment can also include a model improvement criterion wherein one of the top K models is used to replace the deployed ML model 158 only if there is a specified percentage improvement of accuracy of the model over the deployed ML model 158. In an example, the specified percentage improvement can be learnt and dynamically altered with the usage of models over time. This strategy evaluates tradeoffs between the amount of change, the cost of retraining, and the potential value of having a newer model in-production.

The adaptive deployment scheduler 108 determines when the deployed ML model 158 is to be evaluated. The adaptive deployment scheduler 108 is configured to generate a model evaluation trigger based on two criteria which can include a date criterion and a data criterion. The model selector 106 receives the model evaluation trigger and begins evaluating the ML models for replacing the deployed ML model 158. When the adaptive deployment scheduler 108 employs the date criterion, the model evaluation trigger is generated upon determining that a predetermined time has elapsed since the deployed ML model 158 was last evaluated. The predetermined time period for the model evaluation trigger can be configured into the adaptive deployment scheduler 108. When the model evaluation trigger is generated, the accuracy or one or more of the in-production performance metrics and category-wise metrics of the deployed ML model 158 and the top K models with the latest data set that was processed by the external system 150 can be compared and the ML model with the highest accuracy is deployed to the external system 150. For example, the adaptive deployment scheduler 108 can be configured for every “end-of-the-month” scheduling.

When the adaptive deployment scheduler 108 employs the data criterion, the model evaluation trigger is generated upon determining that the accuracy or performance of the deployed ML model 158 has dipped below a predetermined performance level. The model optimization system 100 can provide various graphical user interfaces (GUIs) for the users' to preset the various values e.g., the predetermined periods or the predetermined accuracy thresholds for the model evaluations. For example, the adaptive deployment scheduler 108 can be configured to trigger the model evaluation process after 1000 human corrections have been tracked. In another example wherein the category-wise accuracy is being monitored or tracked, the data criteria can include the category-wise model accuracy criterion. When the accuracy of the deployed ML model 158 pertaining to a particular category falls below the predetermined accuracy threshold, then the adaptive deployment scheduler 108 generates the model evaluation trigger.

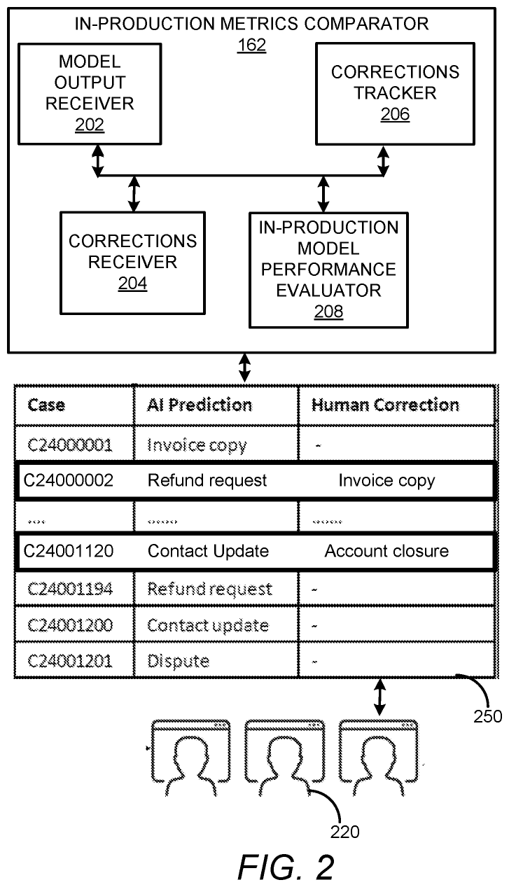

FIG. 2 shows a block diagram of the in-production metrics comparator 164 in accordance with the examples disclosed herein. The in-production metrics comparator 164 includes a model output receiver 202, a corrections receiver 204, a corrections tracker 206, and an in-production model performance evaluator 208. The model output receiver 202 is configured to receive the outputs generated by each of the top K models and the deployed ML model 158 upon processing the input data received by the external system 150. The outputs generated by the models being evaluated are provided to human reviewers 220 by the corrections receiver 204. The outputs may remain unchanged if the human reviewers 220 deem the outputs as valid. However, all the outputs may not be deemed valid and the human reviewers 220 may change some of the outputs. These changes can be received as corrections by the corrections receiver 204. For an example, the human reviewers 220 may provide continuous feedback. Table 250 shows some examples of the outputs produced and corrections received. In table 250, a model output classification of a refund request is corrected as an invoice copy while the contact update is classified as an account closure. For each model thus evaluated, the corrections tracker 206 maintains a count of the number of corrections made to the model's output. The in-production model performance evaluator 208 obtains the output from the corrections tracker 206 to determine the in-production model performance. In an example, certain predetermined thresholds can be configured within the model deployment evaluator 166 to evaluate the performance of some models against the average model performance or other predetermined thresholds.

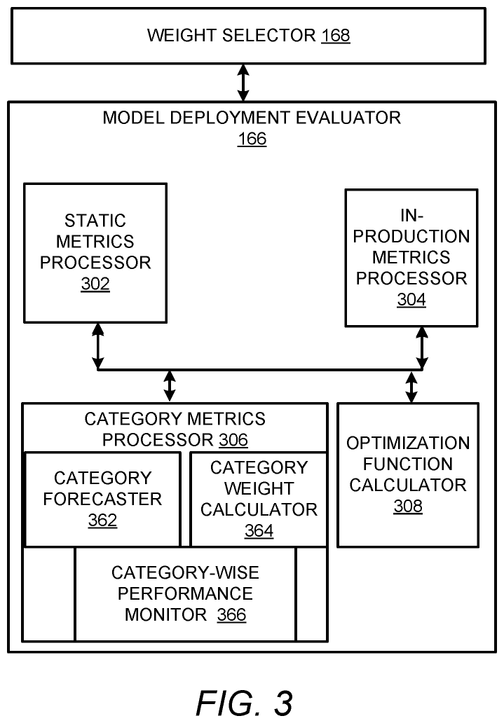

FIG. 3 shows a block diagram of the model deployment evaluator 166 in accordance with the examples disclosed herein. The model deployment evaluator 166 includes a static metrics processor 302, an in-production metrics processor 304, a category metrics processor 306, and an optimization function calculator 308. The model deployment evaluator 166 obtains the weights to be applied to the various components from the weight selector 168. Initially, a nonzero weight can be applied to the model performance under static metrics as only the performance of the plurality of models 142 under static metrics is available. As the model optimization system, 100 continues to receive the input data of the external system 150 to train the plurality of models 142 the in-production performance of the models becomes available and a non-zero weight can be applied to the in-production performance metrics of the plurality of models 142. Based at least on the in-production metrics of the plurality of models 142, the top K models can be selected for deployment to the external system 150.

In an example, category-wise performance metrics are also collected for each of the top K models whenever necessary by the category metrics processor 306. A category forecaster 362 can include a prediction model that outputs predictions regarding one of a plurality of categories that may gain importance in that the input data received by the external system 150 predominantly pertains to that particular category. A category weight calculator 364, also included in the category metrics processor 306, can be configured to weigh specific product categories based on the forecasts or predictions provided by the category forecaster 362. For example, if the external system 150 handles user queries for products on an eCommerce system, then product categories may gain importance depending on the seasons so that summer product categories are predicted as being more popular in the user queries by the category forecaster 362 and hence, are weighed higher during the summer season while gift categories gain importance and are given greater weight during the holiday season. The category metrics processor 306 also includes a category-wise performance monitor 366 that monitors the performance or accuracy of the top K models with respect to the category that has been assigned greater weight. For example, if the deployed ML model 158 is a classifier, then those classifier models which show higher accuracy in identifying the category with greater weight will have a higher value for the category metrics component.

The optimization function calculator 308 generates a cumulative score that aggregates the different components with corresponding weights for each of the top K models. In an example, the various metrics for two models Model 1 and Model 2 and the corresponding weights are shown below:

Static metrics: Model 1: {Acc(avg), Acc (catA), Acc(catB)},

Model 2: {Acc(avg), Acc (catA), Acc(catB)}, W-MLM; wherein Acc(avg) is the average accuracy of the corresponding model (Model 1 or Model 2) for all the categories (i.e., catA and catB in this instance), Acc(catA) is the accuracy of the corresponding model in processing e.g., identifying input data pertaining to category A and similarly, Acc(catB) is the accuracy of the corresponding model for category B and W-MLM is the weight assigned to the static metrics.

In-production performance metrics:

Model 1: {Fallout(Avg), Fallout(catA), Fallout(catB)},

Model 2: {Fallout(Avg), Fallout(catA), Fallout(catB)}, W_IPC:

wherein Fallout(Avg) includes average of the human corrections to the predictions provided by the model, i.e., Model 1 and Model 2 in this instance for category A and category B while Fallout(catA), Fallout(catB) include corrections to the outputs of the models for each category. W_IPC is the weight assigned to the in-production performance metrics.

Category-Wise Metrics:

Model 1:{Vol_forecast(catA), Vol_forecast(catB), . . . },

Model 2:{Vol_forecast(catA), Vol_forecast(catB), . . . }, W CWF; wherein Vol_forecast(catA), Vol_forecast(catB) are volume forecasts of the corresponding models for each of the category A, category B, etc., and W_CWF is the weight assigned to the category-wise metrics component of the model optimization function 172. The model optimization function 172 O(A,H) is obtained as:

O(A, H)=W_ML*Static metrics+W_IPC*In_prod corrections+W_CWF*Categorywise forecast Eq. (1)

where, A=automations (to be maximized), H=human reviews (to be minimized).

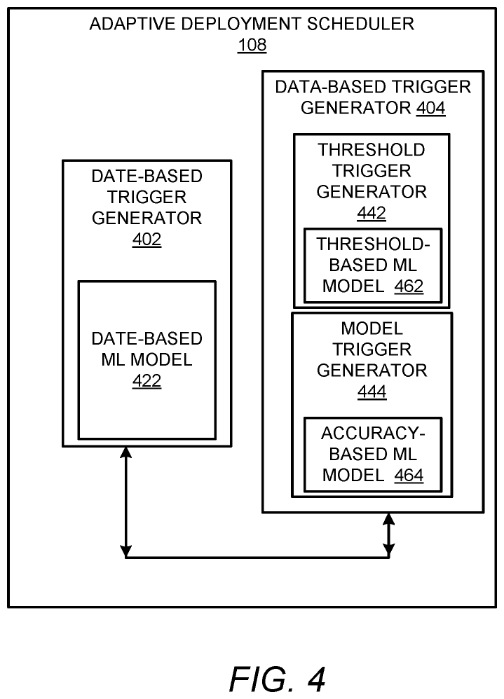

FIG. 4 shows a block diagram of the adaptive deployment of scheduler 108 in accordance with the examples disclosed herein. The adaptive deployment scheduler 108 determines when the deployed ML model 158 should be evaluated based on different criteria that include dates and data. Accordingly, the adaptive deployment scheduler 108 includes a date-based trigger generator 402 and a data-based trigger generator 404. The date-based trigger generator 402 generates a model evaluation trigger upon determining that a predetermined time period has elapsed since the deployed ML model 158 was evaluated. For example, the date-based trigger generator 402 may be configured to generate the model evaluation trigger on a weekly, biweekly or monthly basis. In an example, the date-based trigger generator 402 can be configured with a date-based ML model 422 that is trained on historical data for automatic date-based trigger generation.

The data-based trigger generator 404 generates model evaluation triggers when certain data conditions are identified. Such data conditions can include threshold conditions and model-based conditions. Accordingly, a threshold trigger generator 442 generates the model evaluation triggers when a predetermined threshold is reached in terms of the human corrections provided to the model output. For example, category-wise classification accuracy of each of the plurality of ML models 142 for each category of a plurality of categories can be determined. The model evaluation trigger can be generated upon determining that the category-wise classification accuracy of the deployed ML model 158 for one of the plurality of categories is below a predetermined threshold. The threshold trigger generator 442 includes a threshold-based ML model 462 which can be trained on historical data to automatically set the predetermined threshold for human corrections that will cause the threshold trigger generator 442 to initiate the model evaluation process. The thresholds for human corrections can vary on different factors such as the type of data being processed, the nature of the model being evaluation, the categories that are implemented (if applicable), etc. Similarly, a model trigger generator 444 included in the data-based trigger generator 404 generates a model evaluation trigger when it is determined that one of the top K models provides an improvement in accuracy over a predetermined limit when compared to the deployed ML model 158. The model trigger generator 444 includes an accuracy-based ML model 464 which can also be trained on historical data including the various model accuracy thresholds that were used to trigger the process for evaluation and replacement of the models in the external systems. Different accuracy thresholds can be implemented based on the exact models deployed, the type of data being processed by the deployed models, the category forecasts (if applicable), etc.

In an example the date-based ML model 422, the threshold-based ML model 462 and the accuracy-based ML model 464 can include a forecasting model with an optimization function or a sequential learning model to learn on the collected historical threshold and the time period values. For example, if a Deep Neural Network (DNN) based Long Short Term Memory (LSTM) model is used, it is trained with mean squared error (MSE) loss function. The model architecture contains LSTM layer(s), dropout layer(s), batch normalization layer(s) and finally a fully connected linear activation layer as the output layer. Independent of the model to be used, for each case by case basis, there is a trade-off between long-term model stability/robustness vs. greedy approach to optimize accuracy. Such trade off determines how aggressive the training/re-deployment schedule needs to be. In one example, the outcome of the model is, say, 3 configurable levels (high/medium/low) of aggressiveness of the strategy, which internally would mean different values for one or more parameters. For example, the model improvement or model accuracy threshold may be set to high=2%, medium=7%, low=12%, meaning the new model is deployed if it improves over the prior deployed model by 2, 7, and 12%, respectively. These values 2, 7, and 12 can be learnt. Similarly, time durations “how frequently” can also include different values, e.g., high=weekly/medium=fortnightly/low=monthly.

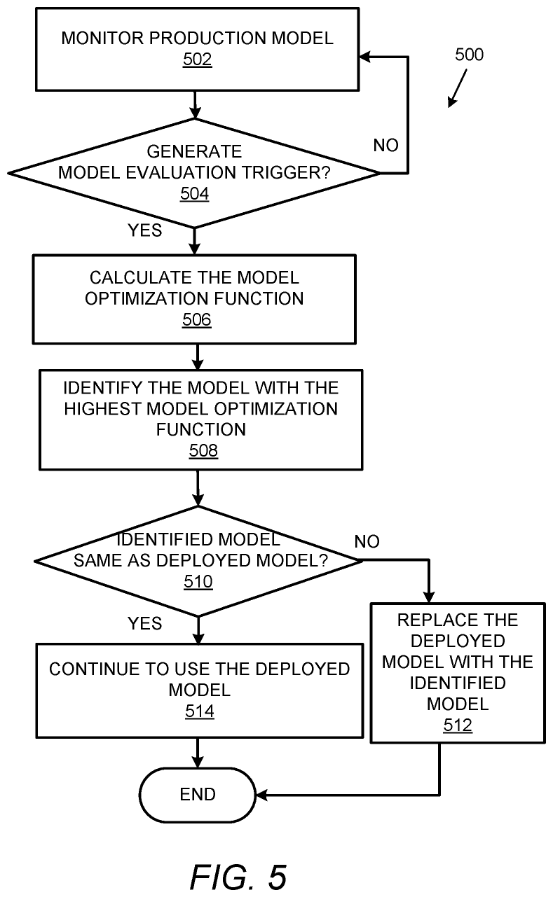

FIG. 5 shows a flowchart 500 that details a method of optimizing an ML model deployed into production on the external system 150 in accordance with examples disclosed herein. The method begins at 502 with monitoring the performance of the deployed ML model 158 so that the optimization procedure can be commenced when the performance of the deployed ML model 158 degrades. Monitoring the performance of the deployed ML model 158 can include accessing output data of the deployed ML model wherein the output data is produced based on the input data received by the external system 150. Collecting the output data enables obtaining various metrics including static metrics, in-production performance metrics, and category-wise metrics as detailed herein. At 504, it is determined if a model accuracy or performance evaluation procedure is to be initiated for the deployed ML model 158 by generating a model evaluation trigger. Different conditions as outlined herein are detected to generate the model evaluation trigger. If it is determined at 504 that no conditions exist for generating the model evaluation trigger, the method returns to 502. If one or more conditions for generating the model evaluation trigger are detected the method moves to 506.

At 506, the model optimization function is calculated for each of the top K models and the deployed ML model 158. At 508, the values of the model optimization function for the different models are compared and the model with the highest value of the model optimization function is identified as the model that is most optimized to execute the necessary tasks at the external system 150. It is determined at 510 if the optimized model identified at 508 is the same as the deployed ML model 158. If it is determined at 510 that the optimized model is the same as the deployed ML model 158, then the deployed ML model 158 continues to be used in the external system 150 at 5144 and the process terminates in the end block. If it is determined at 510 the optimized model is different from the deployed ML model 158 then the deployed ML model 158 is replaced with the optimized model at 512. Therefore, the model optimization system 100 is configured to detect performance degradation of models in-production and replacing such production models.

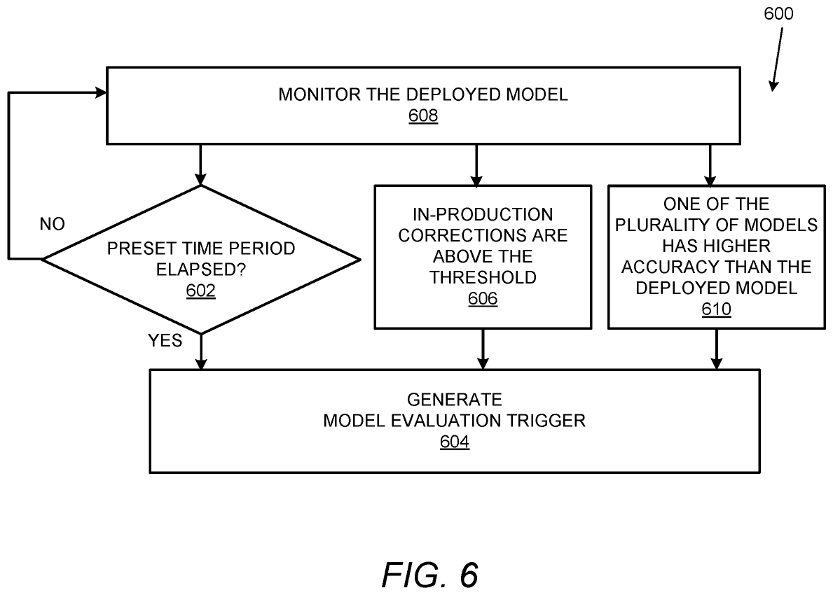

FIG. 6 shows a flowchart 600 that details a method of generating the model evaluation trigger in accordance with the examples disclosed herein. In an example, the process detailed by the flowchart 600 can be implemented by the adaptive deployment scheduler 108 which employs date and data criteria to generate the model evaluation trigger. The date criterion can include a preset or a predetermined time period in which the model evaluation trigger is periodically generated. Accordingly, at 602 wherein it is determined if the preset time period has elapsed. If it is determined at 602 that the predetermined time period has not elapsed, the method moves to 608 wherein the model optimization system 100 continues to monitor the external system 150. If it is determined at 602 that the predetermined time period has elapsed, the method moves to 604 to generate the model evaluation trigger.

The model optimization system 100 may implement a two-fold data criteria for generating the model evaluation trigger which can include a threshold-based criterion and a model-based criterion. Therefore, at 606 the threshold-based criterion is implemented wherein it is determined that the in-production corrections of the deployed ML model 158 are greater than a predetermined corrections threshold. Therefore, the method moves to 604 to generate the model evaluation trigger. The model-based criterion is implemented at 610 wherein it is determined that one of the plurality of models 142 has an accuracy which is better than the accuracy of the deployed ML model 158 by a predetermined percentage and therefore the method moves to 604 to generate the model evaluation trigger. In the instances that category-wise accuracy is relevant, for example, in the case of classification models, the higher accuracy detected at 610 can pertain to one of an average accuracy across different categories or the higher accuracy can pertain to a prioritized category. Therefore, if one of the plurality of models 142 displays higher accuracy in processing input data pertaining to a prioritized category, then the model evaluation trigger may be generated at 604.

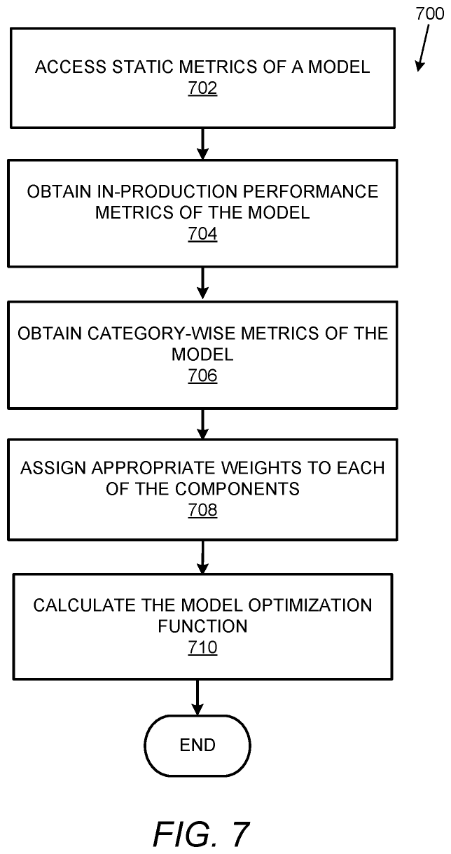

FIG. 7 shows a flowchart 700 that details a method of obtaining the model optimization function in accordance with the examples disclosed herein. The method begins at 702 with accessing the static metrics of a model for which the model optimization function is being calculated. At 704 the in-production performance metrics are obtained. Shown below by way of illustration and not limitation, is a method of calculating the in-production performance metrics in accordance with the examples disclosed herein.

In an example, let w be the window over which the evaluation of the model is conducted so that the time period of the model evaluation ranges from t to t+w. Let α be the data sample being evaluated and n be the total number of classes or categories. Let Al_output_{α} be the category prediction made by the deployed ML model 158 for the data sample α. Let Al_corrected_{α} be the correction made a human reviewer if the Al_output_{α} is misclassified for the data sample Al_output_{α}.

$$Fallout ( {AI\_corrected}_{α} , AI - {output}_{α} ) = \{ \begin{matrix}1 , {AI}_{{corrected}_{α}} = {AI}_{{output}_{α}} \\ 0 , {AI}_{{corrected}_{α}} ! = {AI}_{{output}_{α}}\end{matrix} \qquad Eq . ( 2 )$$

In-production Model Performance w_{c} is defined as the performance of the in-production model over a time period of w and for a category C:

In−Production Model Performance_{c}^{w}=Σ_{α=t}^{t+2}Fallout (AI_{correctedα}, AI_{outputα}) Eq. (3)

Eq. (3) is used to determine the average in-production model performance across all the categories In-Production Model Performance_{avg}^{w}, In-Production Model Performance_{c1}^{w}, In-Production Model Performance_{cs}^{w}, In-Production Model Performance_{cn}^{w}, where c1, c2 . . . cn are the various categories.

At 706, the category-wise metrics are obtained for the model being evaluated. The category-wise metrics can be determined based on volume forecasts. An example calculation for category-wise metrics of two models, Model 1 and Model 2, based on volume forecasts for two categories—A and B, and the corresponding comparison are discussed below by way of illustration. It may be appreciated that the numbers below are discussed by way of illustrating the calculation of category-wise model performance but are not limiting in any manner and that different numbers can be used for calculating the category-wise metrics of various models. Below is a volume forecast table for the models for the categories A and B:

In-production Corrections for:

| | |
|---|---|
| Model 1 | Model 2 |

| Category | Accuracy | Category | Accuracy |
|---|---|---|---|
| A | 86% | A | 75% |
| B | 83% | B | 94% |
| Average | 84.5% | Average | 84.5% |

| | Volume forecast |
|---|---|
| Category | for Period X |
| A | 340 |
| B | 643 |

Considering the volume forecasts tor the categories A and B for the period X and the category-wise classification model accuracy for the categories shown in the tables above, the correct predictions of Model 1 and Model 2 for the categories A and B for the period X can be given as:

### Model 1: Model 2:

| | Volume forecast |
|---|---|
| Category | for Period X |
| A | 340*0.86 = 292 |
| B | 643*0.83 = 533 |

| | Volume forecast |
|---|---|
| Category | for Period X |
| A | 340*0.75 = 255 |
| B | 643*0.94 = 604 |

Based on the in-production corrections shown in the table above, both Model 1 and Model 2 perform identically with an average accuracy of 84.5%. However, based on Period X volume forecast, Model 2 with a correct number of predictions of 859 out of the total number of 983 would outperform Model 1 which has 825 correct predictions for the same total number of 983 predictions during Period X.

The corresponding weights are associated at 708 with each of the components that make up the model evaluation function. As mentioned above, the weights are dynamically learnt with the usage of the model optimization system 100. The model optimization function is obtained at 710 by aggregating the weighted components. In an example, the model optimization function can be represented as:

O(A, H)=Σ_{hu n}x^{k}, w^{k} Eq. (4),

where O represents the model optimization function or a specific model, x represents the component while w represents the corresponding weighting factor.

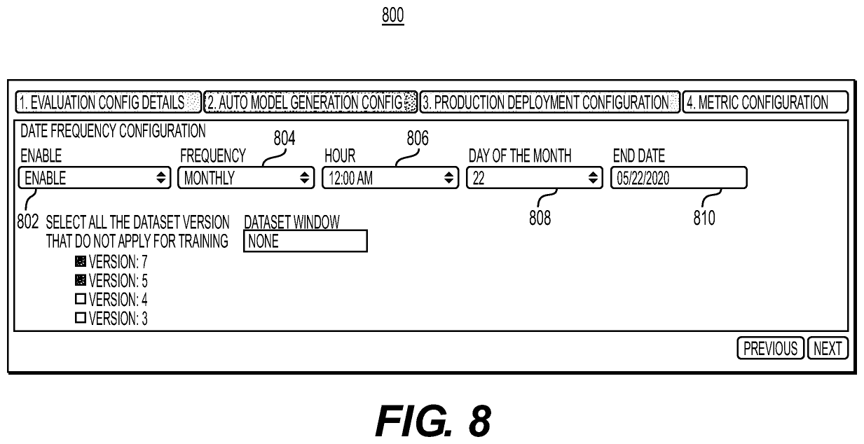

FIG. 8 shows a UI 800 that enables configuring the adaptive deployment scheduler 108 for generating the model optimization trigger by setting attributes in accordance with the examples disclosed herein. More particularly, the UI 800 provides for setting properties for the date-based trigger generation. The user interface 800 includes different UI controls for configuring the different properties of the triggers. The enable combo box 802 allows a user to enable or disable the trigger generation. The frequency combo box 804 allows the user to set the frequency or the predetermined time period that should elapse before the model evaluation is triggered. Other date-based attributes such as the hour 806, the day of the month 808, etc. at which the model evaluation should begin can also be set using the UI 800. Additionally, the end date 810 after which the model evaluation is not automatically triggered can also be set.

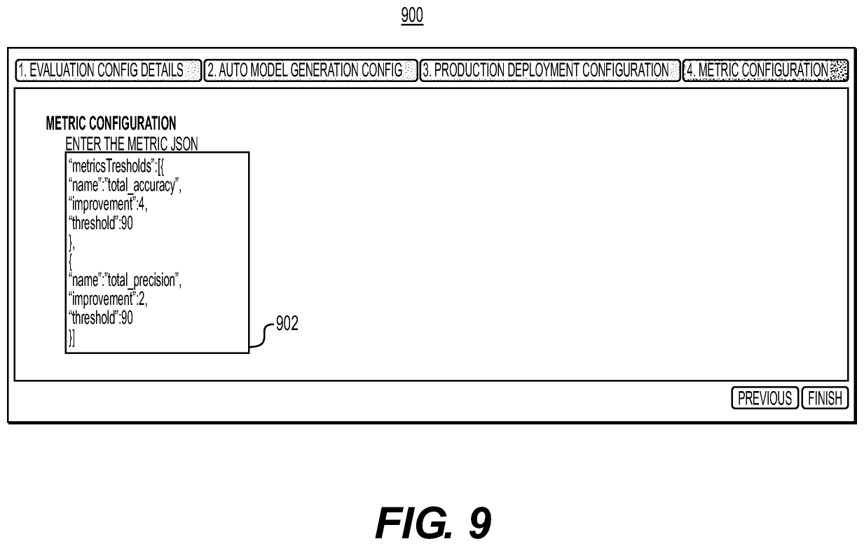

FIG. 9 shows a metrics configuration UI 900 that allows the user to set the threshold for different metrics in accordance with the examples disclosed herein. The metrics configuration UI 900 includes a text box 902 for receiving the various metrics and the corresponding thresholds. For example, a metric named “total accuracy” is set for improvement of ‘4’ with the threshold set at ‘90’. Similarly, another metric named “total precision” is set for improvement of ‘2’ with the threshold set at ‘90’. Based on such values, the deployed ML model 158 had an accuracy above 90 percent and any replacement model should also have an accuracy above 90 percent. While initially, the threshold values are set manually using the UIs described herein, the model optimization system 100 can be configured so that the thresholds are learnt over time and set automatically as the models are evaluated and optimized over a period of time. In an example, historical data including the date based trigger values and model accuracy thresholds that were used over time can be used to train ML models to automatically set the dates and model precision thresholds for triggering the model evaluation procedures as described herein.

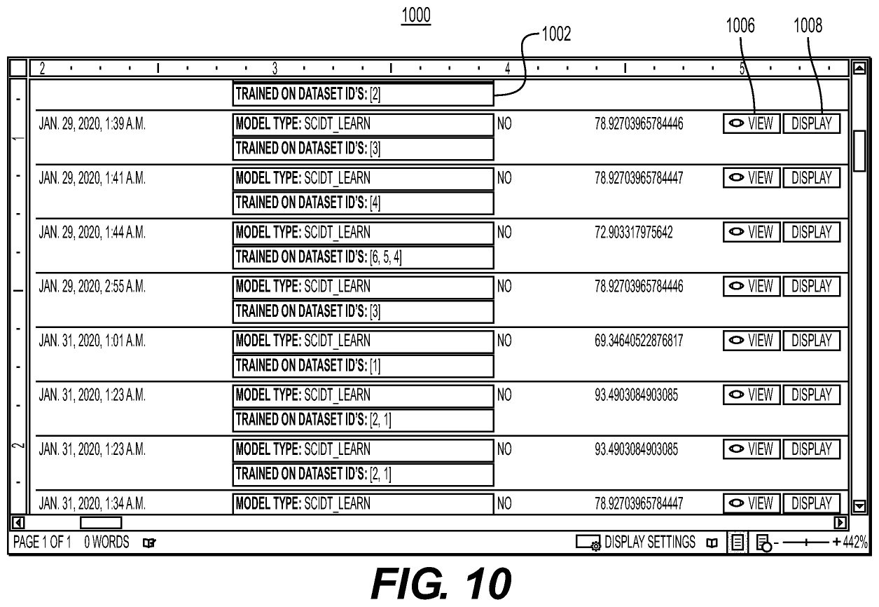

FIG. 10 shows a model deployment UI 1000 provided by the model optimization system 100 in accordance with the examples disclosed herein. More particularly, the model deployment UI 1000 shows a view of a continuous learning. framework. The column 1002 includes a listing of the available, trained models and different data sets used for training the models. Each model has an associated view button 1006 and deploys 1008 are also included to allow users to view the model metrics and to deploy the corresponding model to the external system 150.

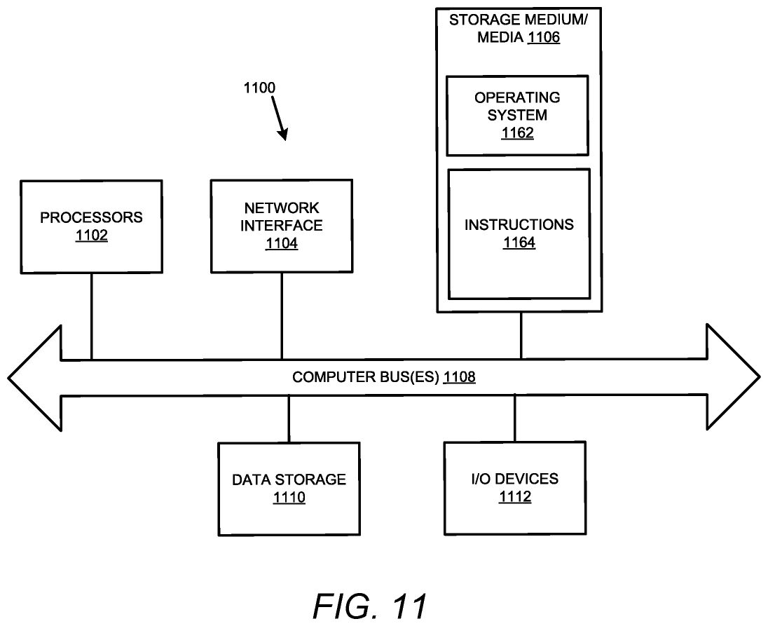

FIG. 11 illustrates a computer system 1100 that may be used to implement the model optimization system 100. More particularly, computing machines such as desktops, laptops, smartphones, tablets, and wearables which may be used to generate or access the data from the model optimization system 100 may have the structure of the computer system 1100. The computer system 1100 may include additional components not shown and that some of the process components described may be removed and/or modified. In another example, a computer system 1100 can sit on external-cloud platforms such as Amazon Web Services, AZURE® cloud or internal corporate cloud computing clusters, or organizational computing resources, etc.

The computer system 1100 includes processor(s) 1102, such as a central processing unit, ASIC or another type of processing circuit, input/output devices 1112, such as a display, mouse keyboard, etc., a network interface 1104, such as a Local Area Network (LAN), a wireless 802.11x LAN, a 3G, 4G or 5G mobile WAN or a WiMax WAN, and a processor-readable medium 1106. Each of these components may be operatively coupled to a bus 1108. The computer-readable medium 1106 may be any suitable medium that participates in providing instructions to the processor(s) 1102 for execution. For example, the processor-readable medium 1106 may be non-transitory or non-volatile medium, such as a magnetic disk or solid-state non-volatile memory or volatile medium such as RAM. The instructions or modules stored on the processor-readable medium 1106 may include machine-readable instructions 1164 executed by the processor(s) 1102 that cause the processor(s) 1102 to perform the methods and functions of the model optimization system 100.

The model optimization system 100 may be implemented as software stored on a non-transitory processor-readable medium and executed by the one or more processors 1102. For example, the processor-readable medium 1106 may store an operating system 1162, such as MAC OS, MS WINDOWS, UNIX, or LINUX, and code 1164 for the model optimization system 100. The operating system 1162 may be multi-user, multiprocessing, multitasking, multithreading, real-time, and the like. For example, during runtime, the operating system 1162 is running and the code for the model optimization system 100 is executed by the processor(s) 1102.

The computer system 1100 may include a data storage 1110, which may include non-volatile data storage. The data storage 1110 stores any data used by the model optimization system 100. The data storage 1110 may be used to store the various metrics, the model optimization function values, and other data that is used or generated by the model optimization system 100 during the course of operation.

The network interface 1104 connects the computer system 1100 to internal systems for example, via a LAN. Also, the network interface 1104 may connect the computer system 1100 to the Internet. For example, the computer system 1100 may connect to web browsers and other external applications and systems via the network interface 1104.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

What is claimed is:

1. A machine learning (ML) model optimization system, comprising:
at least one processor;
a non-transitory processor readable medium storing machine-readable instructions that cause the processor to:
access output data of a ML model deployed in an external system wherein the ML model produces the output data based on input data received at the external system;
generate a model evaluation trigger that initiates a performance evaluation of each of a plurality of ML models that include ML models stored on a model repository and the deployed ML model;
calculate a model optimization function for each of the plurality of ML models, wherein the model optimization function is obtained as a weighted combination of different metrics;
identify a ML model from the plurality of ML models with a highest value of the model optimization function for deployment to the external system;
replace the ML model deployed to the external system with the ML model from the model repository having the highest value of the model optimization function if the ML model with the highest value of the model optimization function is different from the ML model deployed to the external system; and
cont to use the ML model deployed to the external system for processing the input data to produce the output data if the ML model deployed to the external system has the highest value of the model optimization function.

2. The ML model optimization system of claim 1, wherein to generate the model evaluation trigger, the processor is to:
generate the model evaluation trigger upon determining that a predetermined time period has elapsed since the ML model deployed to the external system was evaluated.

3. The ML model optimization system of claim 1, wherein the processor is to further:
track in-production corrections that were made to the output data of each of the plurality of ML models.

4. The ML model optimization system of claim 3, wherein to generate the model evaluation trigger, the processor is to:
generate the model evaluation trigger upon determining that a predetermined percentage of the in-production corrections were made to the output data of the ML model deployed to the external system.

5. The ML model optimization system of claim 1, wherein the processor is to further:
determine category-wise classification accuracy of each of the plurality of ML models for each category of a plurality of categories; and
generate the model evaluation trigger upon determining that the category-wise classification accuracy of the ML model deployed to the external system for one of the plurality of categories is below a predetermined threshold.

6. The ML model optimization system of claim 1, wherein the different metrics include static ML metrics, in-production model performance metrics and category-wise metrics.

7. The ML model optimization system of claim 6, wherein to calculate the model optimization function, the processor is to further:
determine dynamically, corresponding weights to be applied to each of the static ML metrics, the in-production model performance metrics, and the category-wise metrics to generate the weighted combination.

8. The ML model optimization system of claim 7, wherein to dynamically determine the corresponding weights, the processor is to further:
assign the corresponding weights to each of the static ML metrics, the in-production model performance metrics, and the category-wise metrics based on a cause that enables the model evaluation trigger.

9. The ML model optimization system of claim 7, wherein to assign the corresponding weights, the processor is to further:
assign a higher weight to the in-production model performance metrics when it is determined that the model evaluation trigger is generated upon determining that a predetermined percentage of in-production corrections were made to the output data of the ML model deployed to the external system.

10. The ML model optimization system of claim 7, wherein to assign the corresponding weights, the processor is to further:
assign higher weight to the category-wise metrics when it is determined that the model evaluation trigger is generated upon determining that category-wise classification accuracy of the ML model deployed to the external system for a category of a plurality of categories is below a predetermined threshold.

11. The ML model optimization system of claim 10, wherein higher volume of data is forecast for the category as compared to other categories of the plurality of categories and the category is automatically assigned higher priority as compared to other categories of the plurality of categories.

12. The ML model optimization system of claim 1, wherein the plurality of models are ML-based classification models.

13. A method of optimizing a model deployed into production on an external system comprising:
monitoring performance of the deployed model, wherein the monitoring includes receiving an output produced by the deployed model by processing an input;
detecting at least one condition that necessitates generating a model evaluation trigger to evaluate a performance of at least the deployed model, wherein the at least one condition includes one of a date criterion or a data criterion;
generating the model evaluation trigger upon detecting the at least one condition;
calculating a model optimization function for each of a top K models, wherein K is a natural number and the top K models form a subset of K models selected from a plurality of models stored to a model repository, the selection being based on descending order of corresponding model optimization function values;
determining that at least one model of the top K models has higher model optimization function value than the deployed model; and
replacing the deployed model in the external system with the at least one model having the higher model optimization function value than the deployed model.

14. The method of claim 13, further comprising:
receiving in-production corrections from human reviewers to the output data of the deployed ML model.

15. The method of claim 13, further comprising:
providing graphical user interfaces (GUIs) that enable setting attributes for one or more of the date criterion and the data criterion for generating the model evaluation trigger.

16. The method of claim 14, wherein the date criterion includes a predetermined time period in which the model evaluation trigger is to be periodically generated and the data criterion includes a threshold-based criterion and a model-based criterion.

17. The method of claim 16, wherein thresholds for one or more of the threshold-based criterion or the model-based criterion are automatically set based on historical data .

18. The method of claim 14, wherein calculating the model optimization function includes:
obtaining a weighted aggregate of at least static metrics and in-production performance metrics, wherein weights to be applied in the weighted aggregate are automatically learnt.

19. A non-transitory processor-readable storage medium comprising machine-readable instructions that cause a processor to:
access output data of a ML model deployed in an external system wherein the ML model produces the output data based on input data received at the external system;
generate a model evaluation trigger that initiates a performance evaluation of each of a plurality of ML models that include ML models stored on a model repository and the deployed ML model;
calculate a model optimization function for each of the plurality of ML models, wherein the model optimization function is obtained as a weighted combination of different metrics;
identify a ML model from the plurality of ML models with a highest value of the model optimization function for deployment to the external system;
replace the ML model deployed to the external system with the ML model from the model repository having the highest value of the model optimization function if the ML model with the highest value of the model optimization function is different from the ML model deployed to the external system; and
continue to use the ML model deployed to the external system for processing the input data to produce the output data if the ML model deployed to the external system has the highest value of the model optimization function.

20. The non-transitory processor-readable storage medium of claim 19, further comprising instructions that cause the processor to:
receive a forecast for data volume associated with one or more of a plurality of categories to be identified by the deployed ML model, wherein at least one category forecasted as having a higher data volume has a higher priority over other categories of the plurality of categories;
determine category-wise classification accuracy of each of the plurality of ML models for the at least one category; and
generate the model evaluation trigger upon determining that the category-wise classification accuracy of the deployed ML model for the at least one category is below a predetermined threshold.
